(19) United States
(12) Patent Application Publication
(10) Pub. No.: US 2007/0136599 A1
(43) Pub. Date: Jun. 14, 2007

(54) INFORMATION PROCESSING APPARATUS AND CONTROL METHOD THEREOF

(75) Inventor: Yuji SUGA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/470,381

(22) Filed: Sep. 6, 2006

(30) Foreign Application Priority Data
Sep. 9, 2005 (JP) 2005-262989

(51) Int. Cl. H04L 9/00

(52) U.S. Cl. 713/176

(57) ABSTRACT

To provide a mechanism which safely generates a signature even when the reliability of a local terminal is unknown, this invention makes it possible to safely notify a user whether a remote server can trust the local terminal. The mechanism includes a reception acceptance unit adapted to accept a generation request for a digital signature from a user terminal, a terminal authentication unit which authenticates the user terminal, a user authentication unit which authenticates a user who has transmitted the generation request via the user terminal, and a notification unit which notifies the user terminal of an answer to the generation request, on the basis of the authentication results from the terminal authentication unit and user authentication unit

### BACKGROUND OF THE INVENTION

1. Field of the Invention

The present invention relates to an information processing apparatus and a control method thereof.

2. Description of the Related Art

In recent years, along with rapid development and prevalence of computers and their networks, many kinds of information such as text data, image data, audio data, and the like have been digitized. Digital data is free from deterioration due to aging or the like and can be saved in a perfect state forever. In addition, the digital data can be easily copied, edited, and modified.

Such copying, editing, and modifying of digital data are very useful for users, while protection of digital data poses a serious problem. In particular, when documents and image data are distributed via wide area networks such as the Internet and the like, since digital data are readily changed, a third party may tamper the data.

In order for a recipient to detect whether or not incoming data has been tampered, a processing technology called digital signature has been proposed as a scheme for verifying additional data to prevent tampering. The digital signature processing technology can prevent not only data tampering but also spoofing, denial, and the like on the Internet.

Digital signature, a Hash function, public key cryptosystem, and public key infrastructure (PKI) will be described in detail below.

[Digital Signature]

FIGS. 10A and 10B are views for explaining a signature generation process and a signature verification process, and these processes will be described below with reference to FIGS. 10A and 10B. Upon generating digital signature data, a Hash function and public key cryptosystem are used.

Let Ks (2106) be a private key, and Kp (2111) be a public key. A sender applies a Hash process 2102 to data M (2101) to calculate a digest value H(M) 2103 as fixed-length data. Next, the sender applies a signature process 2104 to the fixed-length data H(M) using the private key Ks (2106) to generate digital signature data S (2105). The sender sends this digital signature data S (2105) and data M (2101) to a recipient.

The recipient converts (decrypts) the received digital signature data S (2110) using the public key Kp (2111). The recipient generates a fixed-length digest value: H(M) 2109 by applying a Hash process 2108 to the received data M (2107). A verification process 2112 verifies whether or not the decrypted data matches the digest value H(M). If the two data do not match as a result of this verification, it can be detected that the data has been tampered.

In digital signature, public key cryptosystems such as RSA, DSA (to be described in detail later), and the like are used. The security of these digital signatures is based on the fact that it is difficult for an entity other than a holder of a private key in terms of calculations to counterfeit a signature or to decode a private key.

[Hash Function]

A Hash function will be described below. The Hash function is utilized together with the digital signature processing to shorten a processing time period for an assignment of the signature by applying lossy compression to data to be signed. That is, the Hash function has a function of processing data M having an arbitrary length, and generating output data H(M) having a constant length. Note that the output H(M) is called Hash data of plaintext data M.

Especially, a one-way Hash function is characterized in that if data M is given, it is difficult in terms of a computation volume to calculate plaintext data M′ which meets H(M′)=H(M). As the one-way Hash function, standard algorithms such as MD2, MD5, SHA-1, and the like are available.

[Public Key Cryptosystem]

A public key cryptosystem will be described below. The public key cryptosystem utilizes two different keys, and is characterized in that data encrypted by one key can only be decrypted by the other key. Of the two keys, one key is called a public key, and is open to the public. The other key is called a private key, and is possessed by an identified person.

Digital signatures using the public key cryptosystem, RSA signature, DSA signature, Schnorr signature, and the like are known. In this case, the RSA signature described in R. L. Rivest, A. Shamir and L. Aldeman: “A method for Obtaining Digital Signatures and Public-Key Cryptosystems”, Communications of the ACM, v. 21, n. 2, pp. 120-126, February 1978. will be exemplified. Also, DSA signature described in Federal Information Processing Standards (FIPS) 186-2, Digital Signature Standard (DSS), January 2000 will be explained additionally.

[RSA Signature]

Primes p and q are generated to have n=pq. λ(n) is set as a least common multiple of p−1 and q−1. Appropriate e prime to λ(n) is selected to have a private key d=1/e {mod λ(n}) where e and n are public keys. Also, let H( ) be a Hash function.

[RSA Signature Generation] Signature generation sequence for document M
Let s:=H{M}ˆd (mod n) be signature data.

[RSA Signature Verification] Verification sequence of signature (s, T) for document M

It is verified if H(M)=sˆe (mod n).

[DSA Signature]

Let p and q be primes, and p−1 be a value that divides q. Let q be an element (generator) of order q, which is arbitrarily selected from Z_p* (a multiplicative group excluding zero from cyclic group Z_p of order p). Let x arbitrary selected from Z_p* be a private key to give public key y by y:=gˆx mod p. Let H( ) be a Hash function.

[DSA Signature Generation] Signature generation sequence for document M

1) α is arbitrarily selected from Z_q to have T:=(gˆα mod p) mod q.

2) We have c:=H(M).

3) We have s:=αˆ−1 (c+xT) mod q to set (s, T) as signature data.

[DSA Signature Verification] Verification sequence of signature (s, T) for document M

It is verified if T=(gˆ(h(M) sˆ−1) y ˆ(T s ˆ−1) mod p) mod q.

[Public Key Infrastructure]

In order to access resources in a server in a client-server communication, user authentication is required. As one means of user authentication, a public key certificate such as ITU-U Recommendation X.509 or the like is prevalently used. The public key certificate is data which guarantees binding between a public key and its user, and is digitally signed by a trusted third party called a Certification Authority: CA. A user authentication scheme using SSL (Secure Sockets Layer) used in a browser is implemented by confirming if the user has a private key corresponding to a public key included in the public key certificate presented by the user.

Since the public key certificate is signed by the CA, the public key of the user or server included in it can be trusted. For this reason, when a private key used in signature generation by the CA leaks or becomes vulnerable, all the public key certificates issued by this CA become invalid. Since some CAs manage a huge number of public key certificates, various proposals have been made to reduce the management cost. The present invention to be described later can reduce the number of certificates to be issued and server accesses as a public key repository as its effects.

In ITU-U Recommendation X.509 v.3 described in ITU-U Recommendation X.509/ISO/IEC 9594-8: “Information technology—Open Systems Interconnection—The Directory: Public-key and attribute certificate frameworks”., an ID and public key information of an entity (subject) to be certified are included as data to be signed. By a signature operation such as the aforementioned RSA algorithm or the like for a digest obtained by applying a Hash function to these data to be signed, signature data is generated. The data to be signed has an optional field “extensions”, which can include extended data unique to an application or protocol.

FIG. 11 shows the format specified by X.509 v.3, and information shown in each individual field will be explained below. A “version” field 1501 stores the version of X.509. This field is optional, and represents v1 if it is omitted. A “serial Number” field 1502 stores a serial number uniquely assigned by the CA. A “signature” field 1503 stores a signature scheme of the public key certificate. An “issuer” field 1504 stores an X.500 identification name of the CA as an issuer of the public key certificate. A “validity” field 1505 stores the validity period (start date and end date) of a public key.

A “subject” field 1506 stores an X.500 identification name of a holder of a private key corresponding to the public key included in this certificate. A “subjectPublicKeyInfo” field 1507 stores the public key which is certificated. An “issuerUniqueIdentifier” field 1508 and “subjectUniqueIdentifier” fields 1509 are optional fields added since v2, and respectively store unique identifiers of the CA and holder.

An “extensions” field 1510 is an optional field added in v3, and stores sets of three values, i.e., an extension type (extnId) 1511, critical bit (critical) 1512, and extension value (extnValue) 1513. The v3 “extensions” field can store not only a standard extension type specified by X.509 but also a unique, new, extension type. For this reason, how to recognize the v3 “extensions” field depends on the application side. The critical bit 1512 indicates if that extension type is indispensable or negligible.

The digital signature, Hash function, public key cryptosystem, and public key infrastructure have been described.

Since the digital signature processing technology described above is based on the public key cryptosystem, the amount of calculations for signature generation and signature verification is enormous. In particular, a portable terminal such as a PDA has the problem that the calculation cost of the authentication method based on the public key cryptosystem is higher than that of an ordinary PC. Therefore, an authentication proxy method is proposed which allows even a low-end portable terminal to perform information communication using a certificate authenticated by a certification authority, and reduce the load of operations of, e.g., verification and management of certificates issued by a plurality of certification authorities. (Japanese Patent Laid-Open No. 2001-197055).

In this proposed method, the user terminal need not have any certificate verification function or digital signature function, and can exchange data with a high-secured apparatus or system. There is also provided a mechanism in which the user terminal has a biometrics data input unit for inputting, e.g., a fingerprint capable of biometrics, and an authentication proxy server verifies the input biometrics information. This makes it possible to reliably avoid the use of data by an unauthorized third party even when the user terminal is stolen or lost.

As described above, the digital signature processing technology has the effect of preventing spoofing, data tampering, denial, and the like on the Internet, and the infrastructure for distributing public key certificates is well provided as the reliability infrastructure. Recently, various devices are using this reliability infrastructure, i.e., not only PCs and servers but also household electric information appliances and cellular phones are using the reliability infrastructure. However, devices using the reliability infrastructure are not necessarily reliable for users more often than ever. For example, a portable terminal and office PC normally used by a user contain a user's private key, so the user can reliably use them. On the other hand, the user may sometimes use a device whose reliability cannot be verified. Examples are a kiosk terminal, local PC, and multifunctional peripheral which can be used by a third party. The user must be careful especially when performing processing using his or her private key, i.e., performing a signature generation process in a situation like this.

The signature generation process requires a user's private key which is normally stored in a hard disk of a reliable local machine or in a portable USB dongle. On the other hand, when signing a document generated or scanned by a kiosk terminal, local PC, or multifunctional peripheral described above, the user requires an interface capable of safely loading the private key. Even when the device has the private key loading interface, there is still a menace by which the user signs a document different from the intended document to be signed, i.e., a menace by which even if data to be signed is displayed on the screen, the user signs the tampered document.

The above proposed method provides the mechanism which performs signing by a proxy without carrying any private key. In this method, however, even when correctly authenticating the user, a remote terminal performs signing by a proxy without knowing whether the user can trust a local terminal.

### SUMMARY OF THE INVENTION

The present invention, therefore, makes it possible to safely notify a user whether a remote terminal can rely upon a local terminal, in order to provide a mechanism which safely generates a signature even on a local terminal whose reliability is unknown.

The present invention according to one aspect of preferred embodiments relates to an information processing apparatus comprising, a request acceptance unit adapted to accept a generation request for a digital signature from a user terminal, a terminal authentication unit adapted to authenticate the user terminal, a user authentication unit adapted to authenticate a user who has transmitted the generation request via the user terminal, and a notification unit adapted to notify the user terminal of an answer to the generation request, on the basis of authentication results from the terminal authentication unit and the user authentication unit.

The present invention according to another aspect of preferred embodiments relates to a control method of an information processing apparatus, comprising a request acceptance step of accepting a generation request for a digital signature from a user terminal, a terminal authentication step of authenticating the user terminal, a user authentication step of authenticating a user who has transmitted the generation request via the user terminal, and a notification step of notifying the user terminal of an answer to the generation request, on the basis of authentication results from the terminal authentication step and the user authentication step.

Further features of the present invention will become apparent from the following description of exemplary embodiments (with reference to the attached drawings).

### BRIEF DESCRIPTION OF THE DRAWINGS

FIG. 1 is a view showing an example of the configuration of a system corresponding to an embodiment of the present invention;

FIG. 2 is a view showing an example of a display screen when performing a signing process corresponding to the embodiment of the present invention;

FIG. 3 is a view showing an example of the hardware configuration of an apparatus corresponding to the embodiment of the present invention;

FIG. 4 is an example of a functional block diagram of a digital document generation process corresponding to the embodiment of the present invention;

FIG. 5 is an example of a flowchart of an intermediate digital document generation process corresponding to the embodiment of the present invention;

FIG. 6A is a view for explaining an intermediate digital document and digital data corresponding to the embodiment of the present invention;

FIG. 6B is a view for explaining the intermediate digital document and digital data corresponding to the embodiment of the present invention;

FIG. 7 is an example of a flowchart of a signature information generation process corresponding to the embodiment of the present invention;

FIG. 8 is a view showing an example of the sequence of signature proxy processing corresponding to the first embodiment of the present invention;

FIG. 9 is a view showing an example of the sequence of signature proxy processing corresponding to the third embodiment of the present invention;

FIG. 10A is a schematic view showing a general example of a signature generation process;

FIG. 10B is a schematic view showing a general example of a signature verification process; and

FIG. 11 is a view for explaining the data format of public key certificate X.509 v.3.

### DESCRIPTION OF THE EMBODIMENTS

Preferred embodiments of the present invention will be explained below with reference to the accompanying drawings.

### First Embodiment

This embodiment will explain a digital document generation process which generates compound contents (to be referred to as a digital document hereinafter) by generating a digital signature on image data generated by scanning a paper document or on prestored digital contents.

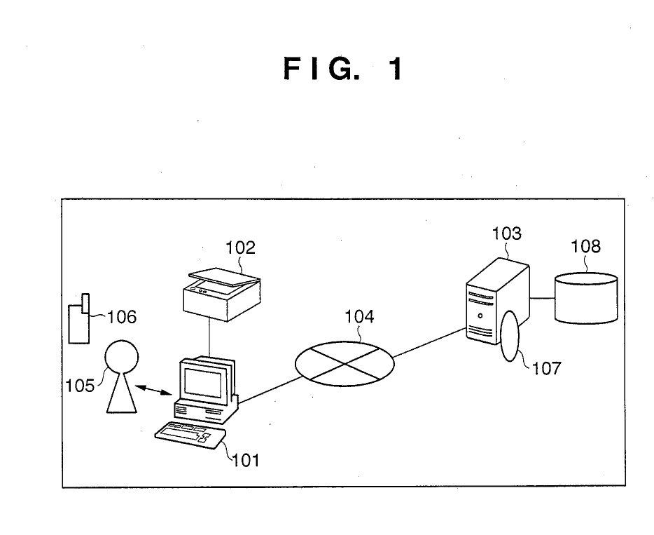

FIG. 1 is a view showing an example of a system corresponding to this embodiment. In this system shown in FIG. 1, a terminal 101 which generates a digital document and a signature proxy server 103 are connected to a network 104. A user 105 generates a digital signature on a digital document stored in the terminal 101, image data input from a scanner 102 connected to the terminal 101, or compound contents of the digital document and image data, by performing a signing process on the terminal 101.

A private key is necessary to perform the signing process. As this private key, it is possible to use a private key stored in the terminal 101 or a private key loaded from a private key loading interface of the terminal 101. It is also possible to download a private key from the signature proxy server 103 across the network. The server 103 has a signature generation daemon (program) 107 for executing the signing process, and is connected to a private key database 108 for managing private keys.

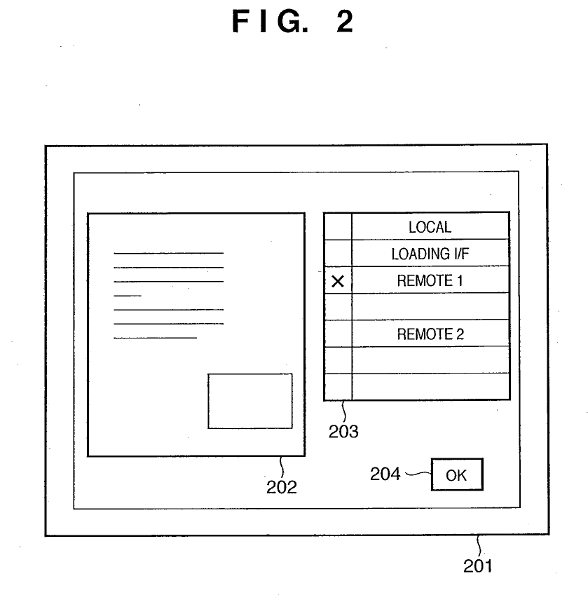

FIG. 2 is a view showing an example of the display screen of a display of the terminal 101 when the user 105 performs the signing process on the terminal 101. Referring to FIG. 2, a display screen 201 displays a display area 202 for data to be signed, a private key selection area 203, and a button 204 for execution of signing process. The user 105 can execute the signing process by confirming data to be signed in the display area 202 for data to be signed, selecting a private key in the private key selection area 203, and pressing the button 204 for execution of signing process.

The private key selection area 203 can select the following three methods: (1) a method which uses a private key stored in the terminal 101; (2) a method which acquires a private key from a private key loading interface of the terminal 101; and (3) a method which downloads a private key from the signature proxy server 103 across the network 104. Note that a plurality of private keys are sometimes stored in the terminal 101 or a plurality of private key input interfaces sometimes exist even for the same method. Furthermore, a plurality of different signature proxy servers may exist. Accordingly, a plurality of choices are displayed for each method.

In particular, method (3) uses the signature generation daemon (program) 107 and private key database 108 in the signature proxy server 103. Additionally, the user 105 can also use a communicating means, such as a portable terminal 106, which uses a channel different from the network 104.

The following explanation will be made by assuming the portable terminal 106 as a communicating means using another channel. However, any means can be used as long as it is a communicating means using a channel different from the network 104 and can transfer information from the signature proxy server 103 to the user 105. Examples are a facsimile apparatus, a fixed telephone, a cell phone, e-mail using another carrier, and mail, but the present invention is not limited to these examples.

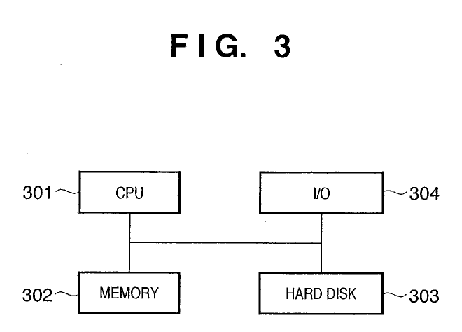

FIG. 3 shows an example of the internal hardware configuration of the terminal 101 and signature proxy server 103. A CPU 301 controls most of the apparatus by executing software. A memory 302 temporarily stores the software to be executed by the CPU 301 and data. A hard disk 303 stores software and data. An input/output (I/O) unit 304 receives input information from a keyboard, mouse, scanner, and the like, and outputs information to a display or printer.

[Digital Document Generation Process]

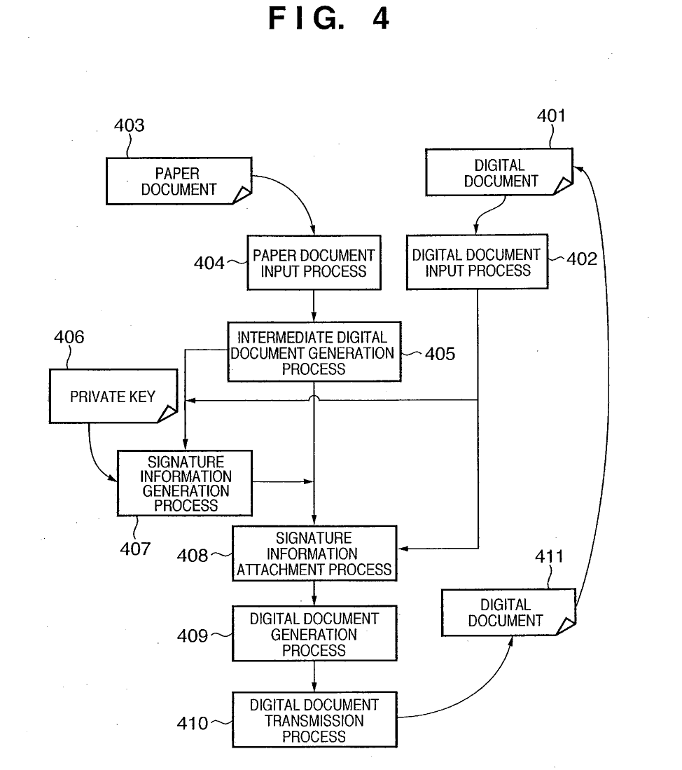

The digital document generation process corresponding to this embodiment will be explained below. FIG. 4 is a functional block diagram showing an example of the digital document generation process of this embodiment.

In the digital document generation process corresponding to this embodiment, a digital document input process 402 inputs a digital document 401. Also, a paper document input process 404 inputs a paper document 403. An intermediate digital document generation process 405 analyzes the input paper document 403 and generates an intermediate digital document. The intermediate digital document, the digital document 401, and a private key 406 are input to a signature information generation process 407 to generate signature information. In addition, a signature information attachment process 408 associates the intermediate digital document, digital document 401, and signature information with each other. Furthermore, a digital document generation process 409 generates a digital document 411 by combining the intermediate digital document, digital document 401, and signature information. A digital document transmission process 410 transmits the digital document 411 outside.

Note that the generated and transmitted digital document 411 may also be input as the digital document 401 to the digital document input process 402 again to regenerate a new digital document 411. Details of the individual functional blocks will be explained below.

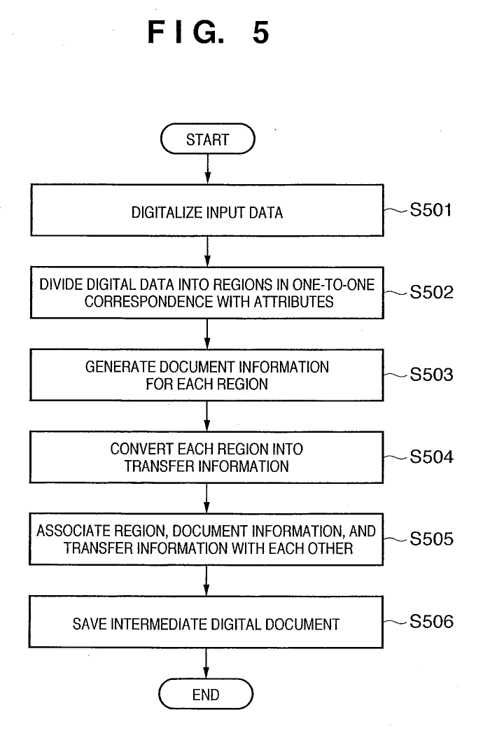

First, details of the intermediate digital document generation process 405 shown in FIG. 4 will be explained. FIG. 5 is a flowchart showing an example of the processing in the intermediate digital document generation process 405 corresponding to this embodiment.

In step S501, digital data is generated by digitalizing data obtained from the paper document input process 404. In step S502, the digital data is divided into regions in one-to-one correspondence with attributes. Examples of the attributes herein mentioned are a character, photograph, table, and line drawing.

For example, the region dividing process can extract a set such as an 8-connected contour mass of black pixels or 4-connected contour mass of white pixels from a document image, and extract a region, such as a character, picture, figure, or table, which characterizes the document, in accordance with the shape, size, state, and the like of the set. This method is described in, e.g., U.S. Pat. No. 5,680,478. Note that the method of implementing the region dividing process is not limited to this method, and another method may also be used.

In step S503, document information is generated for each region obtained in step S502. Examples of the document information are an attribute, layout information such as the position coordinates of a page, a character code string if the attribute of the divided region is a character, and a document logical structure such as a paragraph and the title.

In step S504, each region obtained in step S502 is converted into transfer information. The transfer information is information necessary for rendering. Practical examples are a variable-resolution raster image, a vector image, a monochrome image, a color image, the file size of each transfer information, and a text as the result of character recognition if the attribute of the divided region is a character. Other examples are the position of each individual character, a font, and the reliability of a character obtained by character recognition.

In step S505, the regions divided in step S502, the document information generated in step S503, and the transfer information obtained in step S504 are associated with each other. The associated information is described by a tree structure. The transfer information and document information generated in the above steps will be called constituent elements hereinafter.

In step S506, the constituent elements generated in the preceding stage are saved as an intermediate digital document. The saving format is not particularly limited as long as it can express the tree structure. In this embodiment, the intermediate digital document is saved in an XML form as an example of a structured document.

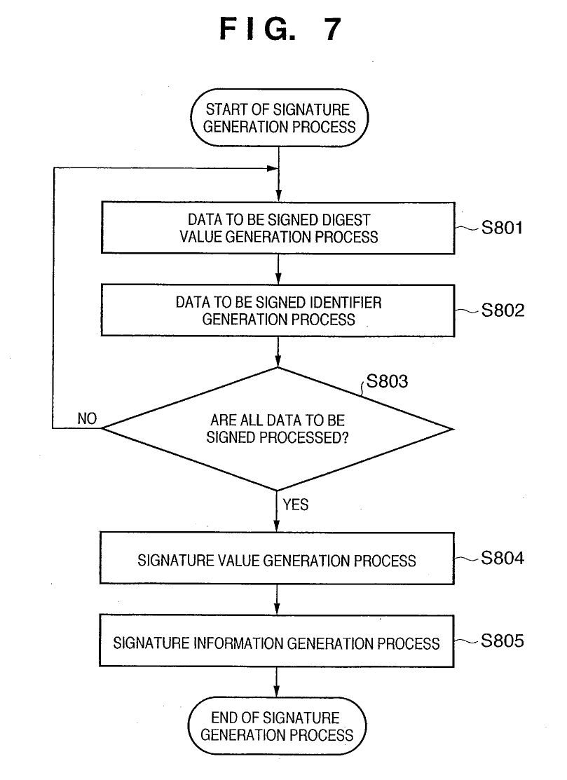

The signature information generation process 407 will be explained below. This process generates a digital signature for the constituent elements of the previously generated intermediate digital document. FIG. 7 is a flowchart of processing in the signature information generation process corresponding to this embodiment. The signature information generation process 407 will be explained below with reference to FIG. 7.

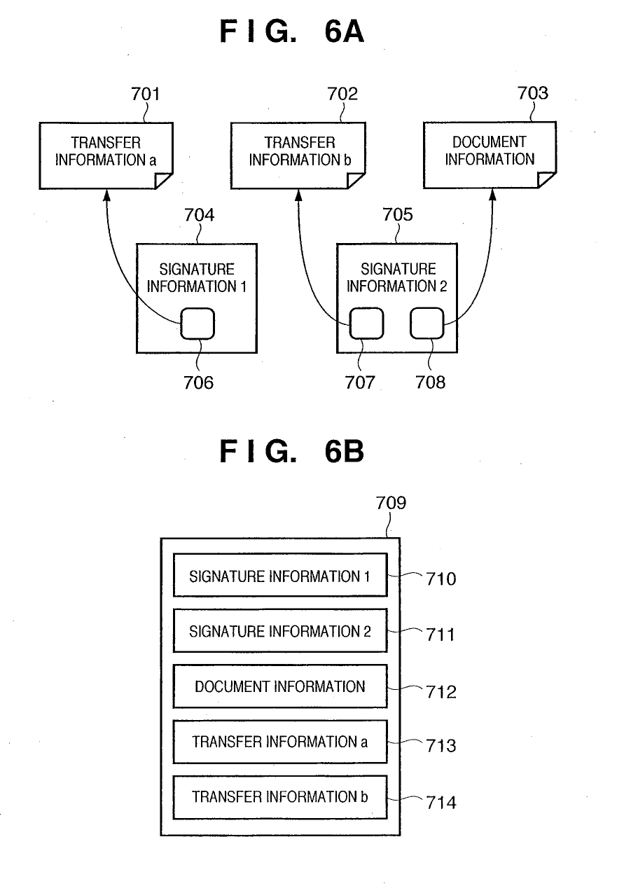

In step S801, a digest value of each data to be signed is generated. The data to be signed is data as an object of signing contained in the intermediate digital document, and can be readily understood when it is regarded as transfer information a 701, transfer information b 702, or document information 703 shown in FIGS. 6A and 6B (to be described later). Also, this embodiment uses the Hash function to generate a digest value. The Hash function is already explained in “BACKGROUND OF THE INVENTION”, so a detailed explanation thereof will be omitted.

In step S802, an identifier of each data to be signed is generated. The identifier need only be capable of uniquely identifying the data to be signed. For example, this embodiment uses a URI defined by RFC2396 as the identifier of the data to be signed. However, the present invention is not limited to this identifier, and various values can be used as the identifier.

In step S803, whether steps S801 and S802 have been applied to all data to be signed is determined. If steps S801 and S802 have been applied to all data to be signed (“YES” in step S803), the flow advances to step S804; if not, the flow returns to step S801.

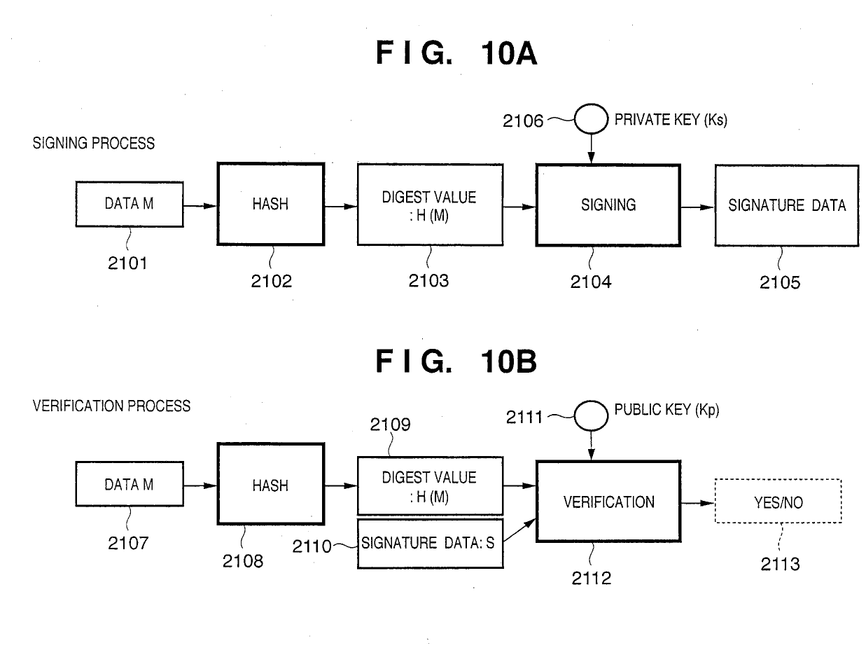

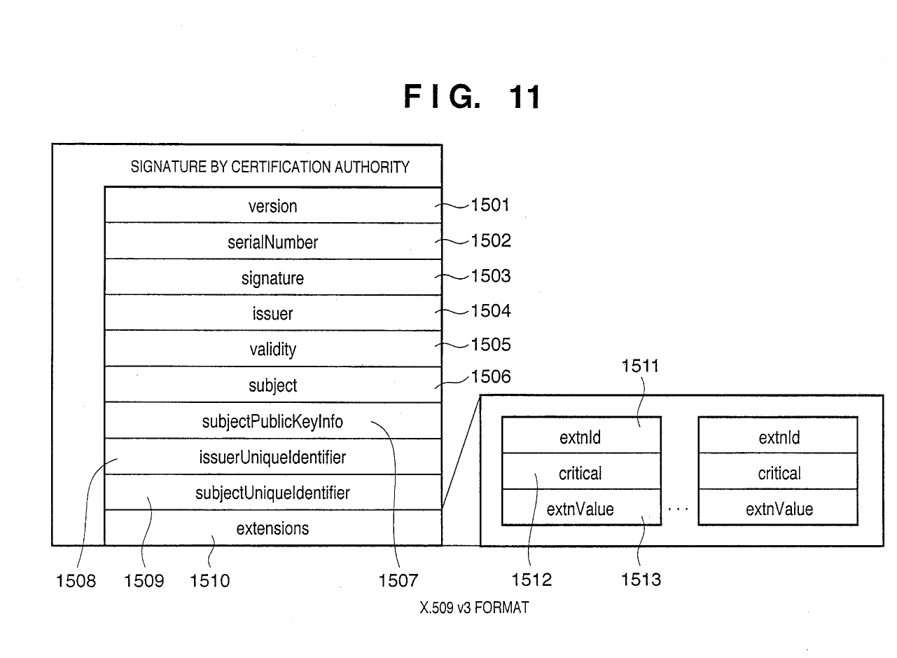

In step S804, the signing process is executed by using the private key 406 for all the digest values generated in step S801 and all the identifiers generated in step S802, thereby calculating a signature value. To calculate the signature value, this embodiment uses the digital signature explained in “BACKGROUND OF THE INVENTION”. For example, the input data: M 2101 in the signature generation process flow shown in FIGS. 10A and 10B corresponds to all the digest values generated in step S801 and all the identifiers (this data group will be called aggregated data hereinafter) generated in step S802. Likewise, the private key Ks 2106 corresponds to the private key 406. Note that a detailed explanation of a practical operation of the digital signature will be omitted.

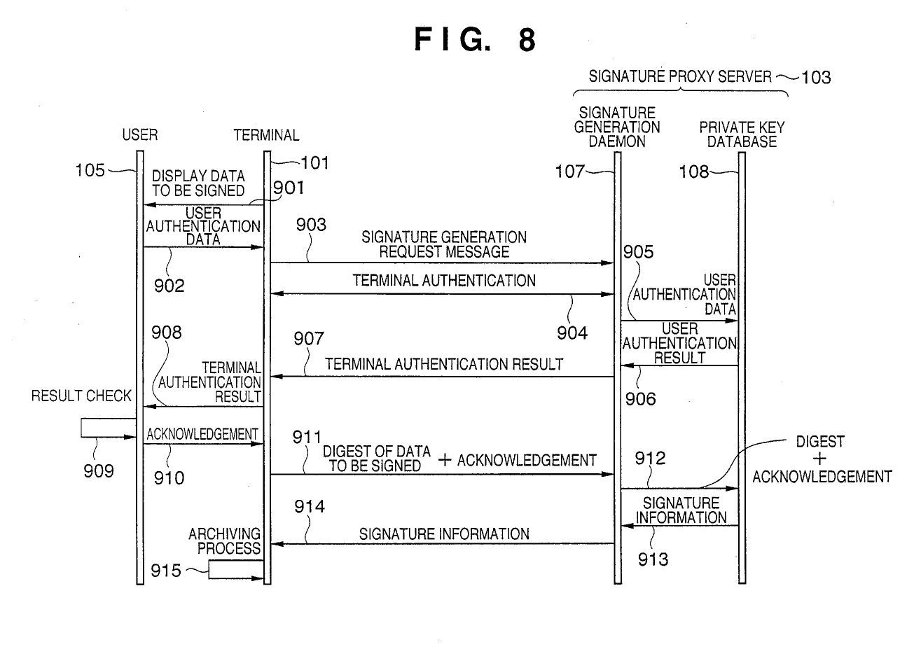

The private key 406 is used by the method selected in the private key selection area 203 shown in FIG. 2. The private key 406 is processed as described previously when it is acquired from the local terminal (terminal 101). An operation of authorizing the remote terminal (signature proxy server 103) to perform the signing process will be described later with reference to FIG. 8.

Subsequently, in step S805, signature information is generated by using the aggregated data (all the digest values generated in step S801 and all the identifiers generated in step S802) and the signature value generated in step S804, thereby completing the signature generation process.

Processing in the signature information attachment process 408 will be explained below with reference to FIG. 6A. Reference numerals 701 and 702 denote the transfer information of the intermediate digital document generated in the intermediate digital document generation process 405; 703, the document information; and 704 and 705, the signature information generated in the signature information generation process 407.

As described above, identification information indicating the transfer information or document information as data to be signed is embedded in the signature information. Referring to FIG. 6A, identification information 706 indicating the data to be signed (i.e., the transfer information 701) is embedded in the signature information 704. The signature data and data to be signed need not have a one-to-one correspondence. For example, identification information 707 and 708 respectively indicating the transfer information 702 and document information 703 of the data to be signed may also be embedded in the signature information 705.

The digital document generation process 409 will be explained below with reference to FIGS. 6A and 6B. As shown in FIG. 6A, the intermediate digital document and signature data generated in the above steps exist as individual independent data. Therefore, the digital document generation process generates a digital document by archiving these data into one data. FIG. 6B is a schematic view showing an example of the archived data of the intermediate digital document and signature data. Archived data 709 corresponds to the digital document 411 shown in FIG. 4. Also, reference numerals 701, 702, 703, 704, and 705 shown in FIG. 6A respectively correspond to reference numerals 713, 714, 712, 710, and 711.

Finally, the digital document transmission process 410 transmits the digital document 411 outside. The generated digital document 411 may also be input as the digital document 401 to the digital document input process again to regenerate a new digital document 411.

The digital document generation process of this embodiment has been explained above.

[Authorization of Signing Process]An operation of authorizing the remote terminal (signature proxy server 103) to perform the signing process will be explained below with reference to FIG. 8. FIG. 8 is a sequence diagram of the signature proxy processing, which is constituted by protocols between the user 105, terminal 101, signature generation daemon 107, and private key database 108.

In 901, the user can confirm the contents of the data to be signed by the display in the display area 202 for data to be signed. On the display screen corresponding to the display example shown in FIG. 2, the private key selection area 203 displays “(3) Use Signature Proxy Server”, and a desired signature proxy server is selected on the basis of the URI. When the user operates the button 204 for execution of signing process, processing from 902 is executed.

In 902, the terminal 101 accepts input user authentication data from the user 105, as an identifier which allows the signature proxy server 103 to authenticate and identify the user 105. The user authentication data can be input not only by inputting a password from the keyboard, but also by selecting appropriate data in accordance with an input means of the terminal. When using a password, it is possible to use not only a fixed word, but also a one-time password which changes in accordance with the time at which a portable terminal is used, or an one-time password for transferring the signature generation right to a different entity.

In 903, the terminal 101 generates a signature generation request message containing the user authentication data input by the user 105, and transmits the message to the signature proxy server 103 (in practice, the signature generation daemon 107 accepts the message). The signature generation request message may also contain a user identifier managed by the signature proxy server 103. This user identifier may also be bound to an authentication behavior for logging in to the terminal 101.

In 904, the signature proxy server 103 performs terminal authentication to determine whether the terminal 101 as the transmission source of the signature generation request message can be trusted. This terminal authentication can be performed by a method based on the policy of the user 105 and signature proxy server 103. Examples are an authentication method using a public key cryptosystem, an authentication method using a public key certificate and public key infrastructure, and an authentication method using a secret key cryptosystem.

In 905, the signature generation daemon 107 analyzes the received signature generation request message to extract the user authentication data, and transmits the extracted data to the private key database 108. 904 and 905 can be performed in parallel or sequentially.

In 906, whether a desired private key exists and the user is an authorized user is determined on the basis of the user authentication data. If a private key exists and the user is an authorized user, a terminal authentication result is returned to the signature generation daemon 107. This terminal authentication result contains data corresponding to the user authentication data. The terminal authentication result is information as an identifier corresponding to the user authentication data input in 902 by the user 105, and can take any form as long as the user can confirm the data. For example, a predetermined password can be used.

In 907, the signature generation daemon 107 transmits the terminal authentication result to the terminal 101, if it is determined by the terminal authentication in 904 that the terminal 101 is a trustable terminal, and the terminal authentication result is obtained from the private key database 108. On the other hand, if the terminal authentication in 904 has failed, or if no terminal authentication result is obtained from the private key database 108, the signature generation daemon 107 transmits dummy data, instead of the terminal authentication result, to the terminal 101.

In 908, the terminal 101 displays the terminal authentication result received from the signature proxy server 103. If the terminal 101 is an unauthorized terminal, or if the user is an unauthorized user, the screen does not display any correct information.

In 909, the user 105 determines whether the contents of the terminal authentication result displayed on the terminal 101 correspond to the user authentication data input in 902. Although the terminal authentication result is displayed in the form of, e.g., a password, it may also be provided by an appropriate means depending on the display function of the terminal 101. In this case, the user 105 may also confirm the correspondence in a random number table.

In 910, the user 105 inputs an acknowledgement to the terminal 101 if he or she determines that the terminal 101 is trustable. This acknowledgement is not limited to a password input from the keyboard, and can be appropriately selected in accordance with another input means of the terminal. Note that when the acknowledgement is a password, it is possible to use not only a fixed password, but also a one-time password which changes in accordance with the time at which a portable terminal is used, or a one-time password for transferring the signature generation right to a different entity. The acknowledgement is an identifier associated with the user authentication data and terminal authentication result described above, and used to determine whether the user 105 has permitted the signature proxy server 103 to sign the data to be signed.

In 911, the terminal 101 transmits the digest, which is the result of the operation performed on the data to be signed by using the Hash function, and the acknowledgement to the signature generation daemon 107. It is also possible to transmit the data to be signed instead of the digest.

In 912, the signature generation daemon 107 transmits the data to be signed or its digest and the acknowledgement to the private key database 108. The private key database 108 searches for a private key associated with the acknowledgement. That is, the private key database 108 determines whether the acknowledgement matches the identifier of the user 105 associated with the private key in advance. If the acknowledgement matches the identifier of the user 105 and the private key exists, the data to be signed or its digest is signed by using the private key, thereby generating signature information.

The generated signature information is returned to the signature generation daemon 107 in 913, and transmitted to the terminal 101 in 914. In 915, the terminal 101 archives the signature information in accordance with the digital document generation process 409, thereby generating the digital document 411.

An operation performed if the terminal 101 is an unauthorized terminal will be explained below. If the terminal 101 is an unauthorized terminal, the signature proxy server 103 detects this information in the terminal authentication 904. Accordingly, no correct terminal authentication result is returned in 907. In 909, therefore, the user 105 can recognize that the terminal 101 is an unauthorized terminal on the basis of the contents displayed on the terminal 101. This allows the user to interrupt the subsequent processing, i.e., the remote signing process using the private key.

Even if the terminal 101 omits steps from 908 to 910 and transmits an unauthorized acknowledgement in 911 to request the user 105 to perform remote signing, the user 105 alone knows the correct acknowledgement. Therefore, even when a private key associated with this unauthorized acknowledgement is searched for, there is no such private key, so it is possible to immediately determine that the acknowledgement is unauthorized. This allows the signature proxy server 103 to detect the unauthorized terminal, and stop the generation of signature information. In this manner, it is possible to provide a mechanism which prevents the formation of signature information by an unauthorized terminal, and safely executes remote signing.

The operation of authorizing the signing process is explained above. This system can provide a mechanism which safely generates a signature even by using a local terminal whose reliability is unknown. That is, the user can be safely notified of the result indicating whether the remote server (signature proxy server 103) can trust the local terminal (terminal 101). Therefore, the user can determine whether to use the local terminal after confirming the reliability of the terminal. In addition, this mechanism can be implemented by using only a random number table describing sets of passwords without using any special device. This advantageously reduces the installation cost.

### Second Embodiment

In the first embodiment explained above, the authorization of the signing process roughly includes the four-way protocols denoted by reference numerals 903, 907, 911, and 914 between the local terminal and remote terminal. However, this embodiment requires only two-way protocols because signature information is embedded in the terminal authentication result in advance.

This embodiment does not perform the flow after 911 in FIG. 8. Instead, the data to be signed or its digest transmitted in 911 and the signature information received in 914 are simultaneously transmitted in 903 and 907.

In 903, a terminal 101 transmits the signature generation request message and the data to be signed or its digest to a signature proxy server 103. The data to be signed or its digest may also be transmitted before the transmission in 903. This allows the signature proxy server 103 to search for a desired private key and sign the data to be signed or its digest by using the private key before transmitting the terminal authentication result in 907. In 906, a private key database 108 returns the user authentication result and signature information to a signature generation daemon 107.

In 907, the signature information can be transmitted in addition to the terminal authentication result. However, the signature information is transmitted after being encrypted since the terminal 101 may be unauthorized. When a user 105 inputs an acknowledgement to the terminal 101 in 910, the terminal 101 can decrypt the encrypted signature information.

The foregoing is the embodiment using the two-way protocols denoted by reference numerals 903 and 907. This makes it possible to obtain the same effects as in the first embodiment by a simplified data flow.

### Third Embodiment

The first and second embodiments described above assume that an unauthorized third party tampers the terminal authentication result displayed on the terminal 101 in 908 of FIG. 8, so the user must manage three associated passwords. The three passwords are the user authentication data, terminal authentication result, and acknowledgement. This also complicates the protocols for implementing the above embodiments.

This embodiment, therefore, assumes a portable terminal 106 which can be trusted by a user 105 as a new entity, and constructs a system by simplified protocols on the premise that data displayed on the portable terminal 106 is trustable.

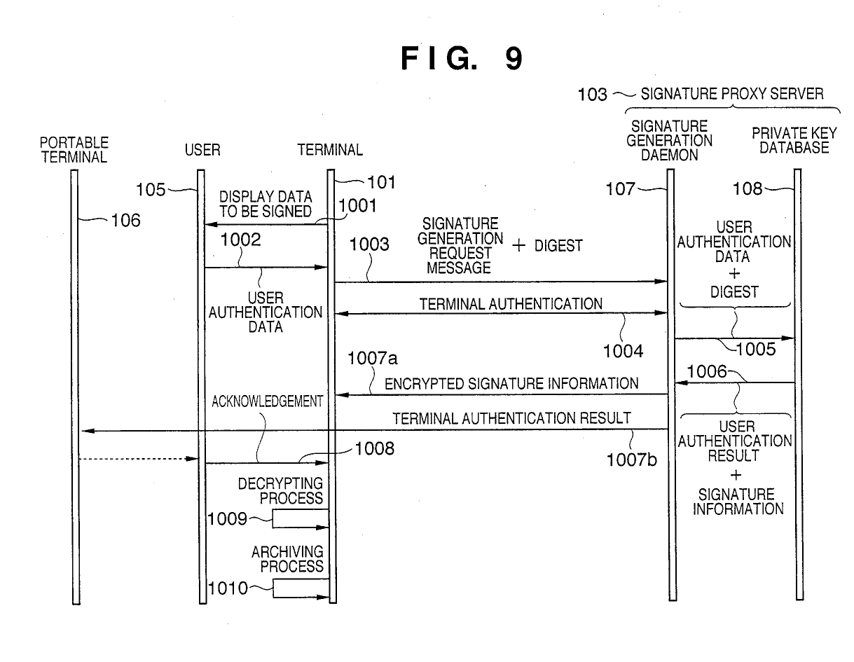

FIG. 9 is a view showing an example of the sequence of signature proxy processing corresponding to this embodiment. Referring to FIG. 9, the portable terminal 106 is added to the user 105, a terminal 101, a signature generation daemon 107, and a private key database 108 shown in FIG. 8. The sequence of this embodiment will be explained below. Note that this embodiment will explain a modification of the second embodiment (two-way protocols), but the embodiment may also be similarly applicable to the first embodiment.

1001 to 1006 in FIG. 9 are the same as 901 to 906 in the second embodiment, so an explanation thereof will be omitted, and processing from 1007 will be explained below.

The processing in 907 of FIG. 8 is divided into 1007a and 1007b in FIG. 9. In 1007a, the encrypted signature information is transmitted to the terminal 101. In 1007b, the terminal authentication result is transmitted to the reliable portable terminal 106 instead of the terminal 101. As in the above embodiments, the terminal authentication result may also be another data previously associated with the user authentication data input in 1002. If it is possible to confirm that a signature proxy server 103 is the transmission source, the terminal authentication result may also be the same as the user authentication data.

In 1008, if the user 105 determines that the terminal 101 is trustable on the basis of the terminal authentication result received in 1007b, the user 105 inputs an acknowledgement to the terminal 101. This acknowledgement may also be transferred together with the terminal authentication result to the user 105 via 1007b. In this case, the user 105 need only manage one password for one transaction.

When receiving the input acknowledgement from the user 105, the terminal 101 decrypts the encrypted signature information in 1009. In 1010, the terminal 101 generates a digital document 411 by archiving the data in accordance with a digital document generation process 409.

In this manner, the number of passwords to be managed by the user can be reduced. More specifically, in the first and second embodiments, the user must manage three passwords for one transaction. In this embodiment, however, the user need only manage one password for one transaction. This greatly improves the user friendliness.

### Embodiment Using Another Encryption Algorithm

The above embodiments do not mention any encryption (concealing) method. However, the present invention is readily applicable not only to an encryption method using the public key cryptosystem but also to an encryption method using the secret key cryptosystem. Accordingly, the present invention also includes a case in which the above embodiments are implemented by using another encryption algorithm.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM, DVD-R or DVD-RW).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-262989, filed Sep. 9, 2005, which is hereby incorporated by reference herein in its entirety.

What is claimed is:

1. An information processing apparatus comprising:
a request acceptance unit adapted to accept a generation request for a digital signature from a user terminal;
a terminal authentication unit adapted to authenticate the user terminal;
a user authentication unit adapted to authenticate a user who has transmitted the generation request via the user terminal; and
a notification unit adapted to notify the user terminal of an answer to the generation request, on the basis of authentication results from said terminal authentication unit and said user authentication unit.

2. The apparatus according to claim 1, further comprising:
a search unit adapted to search for a private key stored in a database, in response to the generation request;
a receiver which receives a digital document to be signed from the user terminal;
a signature generation unit adapted to generate the digital signature of the digital document to be signed, by using the private key; and
a transmitter which transmits the digital signature to the user terminal.

3. The apparatus according to claim 2, wherein,
the database stores the private key in association with a plurality of identifiers each of which identifies a user of the private key,
said search unit searches for a private key associated with a first identifier of the plurality of identifiers, wherein the first identifier is contained in the generation request, and
said user authentication unit authenticates the user as an authorized user, if the private key associated with the first identifier is stored in the database.

4. The apparatus according to claim 3, wherein if said terminal authentication unit authenticates the user terminal as an authorized terminal, and said user authentication unit authenticates the user as an authorized user, said notification unit performs the notification by embedding a second identifier of the plurality of identifiers in the answer.

5. The apparatus according to claim 3, wherein if said terminal authentication unit does not authenticate the user terminal as an authorized terminal, or if said user authentication unit does not authenticate the user as an authorized user, said notification unit performs the notification by embedding none of the plurality of identifiers in the answer.

6. The apparatus according to claim 3, wherein
said receiver further receives information for designating the private key, and
said signature generation unit determines whether or not the received information matches a third identifier of the plurality of identifiers, and generates the digital signature if it is determined that the received information matches the third identifier.

7. The apparatus according to claim 2, wherein
said receiver receives the digital document to be signed together with the generation request for the digital signature, and
said transmitter encrypts and transmits the digital signature when transmitting the digital signature together with notification of the answer.

8. The apparatus according to claim 1 wherein said notification unit transmits the answer to a second user terminal different from a first user terminal having sent the generation request.

9. The apparatus according to claim 8, wherein the first identifier, the second identifier, and the third identifier are the same identifier.

10. A control method of an information processing apparatus, comprising:
a request acceptance step of accepting a generation request for a digital signature from a user terminal;
a terminal authentication step of authenticating the user terminal;
a user authentication step of authenticating a user who has transmitted the generation request via the user terminal; and
a notification step of notifying the user terminal of an answer to the generation request, on the basis of authentication results from the terminal authentication step and the user authentication step.

11. The method according to claim 10, further comprising:
a search step of searching for a private key stored in a database, on the basis of the generation request;
a reception step of receiving a digital document to be signed from the user terminal;
a signature generation step of generating the digital signature of the digital document to be signed, by using the private key; and
a transmission step of transmitting the digital signature to the user terminal.

12. The method according to claim 11, wherein
the database stores the private key in association with a plurality of identifiers each of which identifies a user of the private key,
in the search step, a private key associated with a first identifier of the plurality of identifiers is searched for, wherein the first identifier is contained in the generation request, and
in the user authentication step, the user is authenticated as an authorized user if the private key associated with the first identifier is stored in the database.

13. The method according to claim 12, wherein if the user terminal is authenticated as an authorized terminal in the terminal authentication step, and the user is authenticated as an authorized user in the user authentication step, the notification is performed in the notification step by embedding a second identifier of the plurality of identifiers in the answer.

14. The method according to claim 12, wherein if the user terminal is not authenticated as an authorized terminal in the terminal authentication step, or if the user is not authenticated as an authorized user in the user authentication step, the notification is performed in the notification step by embedding none of the plurality of identifiers in the answer.

15. The method according to claim 12, wherein
information for designating the private key is further received in the reception step, and
in the signature generation step, whether or not the received information matches a third identifier of the plurality of identifiers is determined, and the digital signature is generated if it is determined that the received information matches the third identifier.

16. A computer program stored in a computer readable medium, wherein said computer program causes a computer to execute a control method according to claim 10.
